(19) United States
(12) Patent Application Publication
(10) Pub. No.: US 2011/0187549 A1
(43) Pub. Date: Aug. 4, 2011

(54) SMART MEDICINE CABINET

(76) Inventor: Arjun Varman Balasingam, San Jose, CA (US)

(21) Appl. No.: 12/698,943

(22) Filed: Feb. 2, 2010

(51) Int. Cl. G08B 21/00; A47B 81/00; B65D 85/00

(52) U.S. Cl. 340/687; 312/209; 215/370

(57) ABSTRACT

Disclosed is a medicine cabinet, comprising; a housing having at least one shelf to support at least one medicine bottle thereon; and a sensing arrangement within the housing, the sensing arrangement monitors dispensing of medicine from each medicine bottle, wherein the sensing arrangement detects pickup of each medicine bottle from each shelf.

### TECHNICAL FIELD

The present disclosure relates to a medicine cabinet.

### BACKGROUND

Often, people either forget to take their medicines on time or forget that they have already taken their medicines. In the latter case, the person may duplicate a dosage. Clearly, what is needed is a system that avoids the former and the latter problems.

### SUMMARY

In one aspect, the present disclosure provides a medicine cabinet, comprising: a housing having at least one shelf to support at least one medicine bottle thereon; and a sensing arrangement within the housing, the sensing arrangement monitors dispensing of medicine from each medicine bottle, wherein the sensing arrangement detects pickup of the each medicine bottle from each shelf.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

FIG. 1 is a perspective view of a medicine cabinet, in accordance with an embodiment of the present disclosure.

### DETAILED DESCRIPTION

Before describing in detail embodiments that are in accordance with the present disclosure, it should be observed that the embodiments reside primarily in combinations of system components related to a medicine cabinet.

As used herein, relational terms such as first and second, and the like may be used solely to distinguish one module or action from another module or action without necessarily requiring or implying any actual such relationship or order between such modules or actions. The terms “comprises,” “comprising,” or any other variation thereof, are intended to cover a non-exclusive inclusion, such that a process, method, article, or apparatus that comprises a list of elements that does not include only those elements but may include other elements not expressly listed or inherent to such process, method, article or apparatus. An element proceeded by “comprises . . . a” does not, without more constraints preclude the existence of additional identical elements in the process, method, article, or apparatus that comprises the element.

The present disclosure provides a medicine cabinet having a sensing arrangement which may enable one to infer medicine dispensing events, and communicate that information to caregivers and vendors of products and services. Advantageously, the medicine cabinet records all the medicine dispensing events. The recorded information may be used by people who tend to forget to take their medicines or forget that they have already taken their medicines. Thus, the recorded information helps people to take right doses of medicines on time.

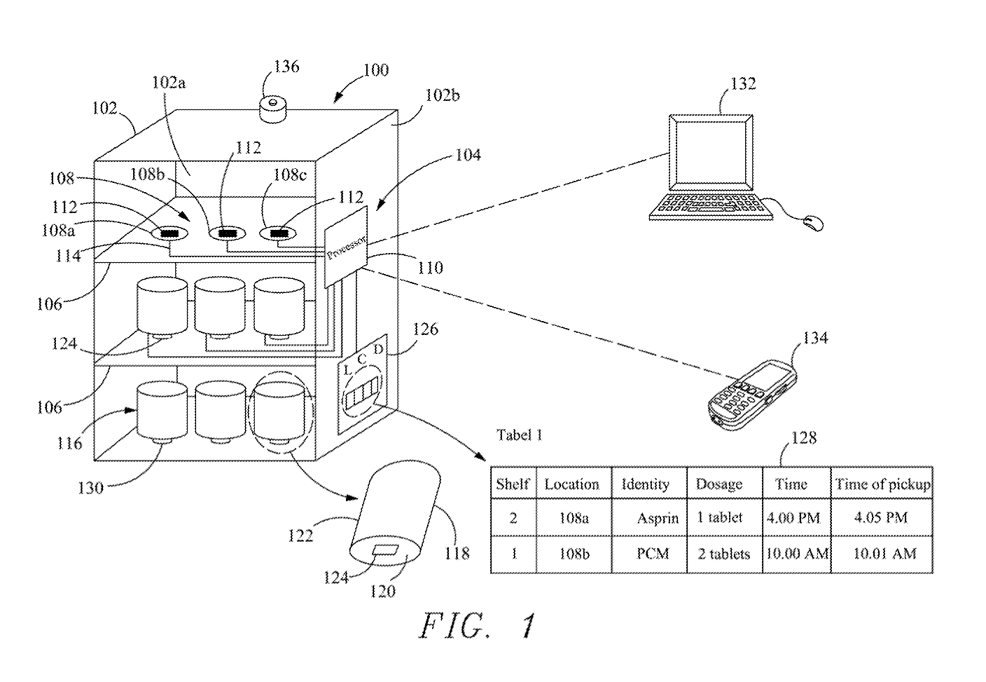

Referring to FIG. 1, a perspective view of a medicine cabinet 100 is shown, in accordance with an embodiment of the present disclosure. The medicine cabinet 100 includes a housing 102 and a sensing arrangement 104 within the housing 102. The housing 102 is defined by a planar base member 102a and sidewalls 102b extending upwardly from the planar base member 102a, thereby creating a space therebetween, as shown in FIG. 1. The medicine cabinet 100 may further include a door (not shown) attached to the housing. In the present embodiment, the housing 102 is made of wood; however, in another embodiment the housing 102 may be made of any other suitable material such as plastic.

In one embodiment, the housing 102 may include a plurality of shelves 106. The shelves 106 may be installed in the space created by the planar base member 102a and the sidewalls 102b. Specifically, the shelves 106 may be removably attached to the sidewalls 102b in the space. In one embodiment, each shelf 106 may have markings 108 thereon, such as a first marking 108a, a second marking 108b, and a third marking 108c, as shown in FIG. 1. The markings 108 may be either be drawn or engraved on each shelf 106. The purpose of the markings 108 will be explained later. In the present embodiment, the housing 102 is shown to have three shelves 106; however in another embodiment the housing 102 may have any number of shelves.

In one embodiment, the sensing arrangement 104 comprises a processor 110 and a plurality of first electrical contacts 112. Each of the plurality of first electrical contacts is located proximate to a marking 108 on the shelf 106. Further, each of the first electrical contacts 112 is coupled to the processor 110 via conductive lines 114, as shown in FIG. 1. At each marking 108a, 108b, and 108c on the shelf 106, a plurality of medicine bottles 116 may be placed.

In one embodiment, the medicine bottle 116 may include a body 118 having a base member 120 and a peripheral, sidewall 122 extending upwardly therefrom. Each medicine bottle 116 is capable of containing medicines such as tablets and syrups. The medicine bottle 116 further includes a second electrical contact 124 proximate to the base member 120 of the body 118. In one embodiment, the second electrical contact 124 is fastened or press fitted to an underside of the base member 120 of the body 118, as shown in FIG. 1. However, in another embodiment, the second electrical contact 124 is embedded at the underside of the base member 120 of the body 118.

When medicine bottles 116 are placed on the shelf 106 at the markings 108a, 108b, and 108c; the respective first electrical contacts 112 at the shelf 106 make a closed circuit contact with the respective second electrical contacts 124 of the medicine bottles 116. The markings thus serve as a placement guide for the pill bottles. Specifically, as soon as the medicine bottles 116 are placed at the markings 108, a first signal informing about the placement of the medicine bottles 116 on the shelf 106 is transmitted to the processor 110. The processor 110, which is coupled to a display screen 126, may facilitate displaying a table 128 containing information about all the medicine bottles 116 in the medicine cabinet 100. The table 128 contains information about the shelf 106 in which a medicine bottle 116 is placed, location of a medicine bottle, identity of a medicine bottle, dosage of a medicine, time of dosage, and pickup time of the medicine bottle, as shown in FIG. 1. In one embodiment, the display screen 126 may be Liquid Crystal Display or a touch screen attached to the sidewall 102b of the housing 102.

When a medicine bottle 116 is picked up from the shelf 106, the closed circuit contact between the first electrical contact 112 and the second electrical contact breaks. The breaking of the closed circuit contact may send a second signal to the processor 110. The second signal may trigger the processor 110 to record information related to at least one of a time of pickup of the medicine bottle 116 and an identity of the medicine bottle 116 being picked-up. The recoded information may be displayed in the table 128 on the display screen 126. Therefore, the processor 110 facilitates monitoring the dispensing of medicines from the medicine bottles 116 in the medicine cabinet 100 and thereby keeps track of all medicine dispensing events.

In another embodiment, the first electrical contacts 112 and the second electrical contacts 124 may be replaced by a plurality of pressure sensors 130. Specifically, in this embodiment, the plurality of pressure sensors 130 may be coupled to the processor 110 via the conductive lines 114. Further, the pressure sensors 130 may be fitted at the markings 108 on the shelf 106. At each marking 108 on the shelf 106, a medicine bottle 116 is placed. Specifically, the medicine bottles 116 are placed on the pressure sensors 130. When a medicine bottle is picked up, the pressure sensor sends a signal to the processor 110. The signal may trigger the processor 110 to record information related to at least one of a time of pickup of the medicine bottle 116 and an identity of the medicine bottle 116 being picked-up. The recoded information may be displayed in the table 128 on the display screen 126.

In one embodiment, the pressure sensors 130 are precise to milligrams and may measure a weight of the medicine bottle 116 each time it is picked up and placed back to determine whether a user actually consumed a medicine after picking up the medicine bottle. Specifically, if the weight of the medicine bottle 116 before it was picked up is more than it's weight after it was placed back, the user is assumed to have consumed the medicine. In another embodiment, the pressure sensors 130 may not be as precise. In this embodiment, each time a medicine bottle 116 is picked up, the processor 110 may record it as a dispensing event. Alternatively, when the medicines are tablets or pills, the pills may be filled with filler materials to increase the weight of each pill so that the pressure sensors 130 may accurately measure the dispensing of the pills from the medicine bottle.

In the present embodiment, the processor 110 may update the display screen 126 with the recorded information regularly, as well as with data which is received by the processor 110 from the Internet by caregivers and vendors. In another embodiment, the recorded information may be sent to a web enabled computer 132, coupled to the processor 110, so as to maintain an up-to-date and secure web page that keeps track of the medicines being consumed. Therefore, the recorded information may help a user to keep to a track of medicines which have already being consumed. In the present embodiment, the computer 132 may be a desktop, a laptop, or a Personal Digital Assistant.

In one embodiment, the processor 110 may facilitate transmitting an alert message to at least one of a caregiver and a user when a medicine bottle 116 is not picked-up in a predefined time slot. The predefined time slot may be defined by the user or by the caregiver for each medicine bottle 116 in the medicine cabinet 100. The predefined time slot is a time period within which a medicine bottle 116 should be picked up.

In one embodiment, the alert message may include at least one of an email, an audio alarm, and a Short Messaging System (SMS). Specifically, the email may be sent to the computer 132 which is web enabled. The SMS may be sent to a mobile phone 134 which may be coupled to the processor 110. The audio alarm may go loud with the help of an alarm 136 which may be coupled processor 110 via conductive lines (not shown).

The present disclosure provides a medicine cabinet which is fully powered at all limes during its operation. In practice, several optimizations may be implemented to conserve power. For instance, the bulk of the medicine cabinet may be maintained in a dormant stale, until a user opens the cabinet. So, only one sensor which detects the opening of the cabinet will need to remain powered at all times. Further, the medicine cabinet may comprise the touch screen so that a patient may enter symptoms and other indicators which may be used to assess the efficacy of the medicines. The medicine cabinet is web-enabled and may be used to look for correlations between the intake of medicines, and the evolution of symptoms, or vital signs (e.g. temperature, blood pressure etc.) to modify prescription of medicines. The medicine cabinet may also be used by medicine venders for placing automatic orders to replenish depleted medicines.

We claim:

1. A medicine cabinet, comprising:
a housing having at least one shelf to support at least one medicine bottle thereon; and
a sensing arrangement within the housing, the sensing arrangement to monitor dispensing of medicine from each medicine bottle, wherein the sensing arrangement detects pickup of each medicine bottle from each shelf.

2. The medicine cabinet of claim 1, wherein the sensing-arrangement further comprises a plurality of first electrical contacts.

3. The medicine cabinet of claim 2, wherein each shelf further comprises markings thereon, wherein the plurality of first electrical contacts are located proximate to the markings to guide placement of each pill bottle on the shelf to trigger a signal through a first electrical contact.

4. The medicine cabinet of claim 3, wherein sensing arrangement further comprises a processor which receives a signal from a first electrical contact when a corresponding medicine bottle is picked-up from the shelf.

5. The medicine cabinet of claim 1, wherein the monitoring comprises recording information related to at least one of a time of pickup and identity of a medicine bottle being picked-up.

6. The medicine cabinet of claim 5, further comprising a display screen attached to the housing, wherein the display screen displays the recorded information.

7. The medicine cabinet of claim 4, wherein the processor is further capable of facilitating transmitting an alert message to at least one of a caregiver and a user when a medicine bottle is not picked-up in a predefined time slot.

8. The medicine cabinet of claim 7, wherein the alert message comprises at least one of an email, an audio alarm, and a Short Messaging System (SMS).

9. The medicine cabinet of claim 1, wherein the sensing arrangement further comprises pressure sensors.

10. The medicine cabinet of claim 9, wherein each shelf further comprises markings thereon, wherein the pressure sensors are proximate to the markings to guide placement of each pill bottle on the shelf to trigger a signal through a pressure sensor.

11. The medicine cabinet of claim 10, wherein sensing arrangement further comprises a processor which receives a signal from a pressure sensor when a corresponding medicine bottle is picked-up from the shelf.

12. A medicine bottle, comprising:
a body having a base member and a peripheral sidewall extending upwardly therefrom; and
an electrical contact proximate to the base member of the body.

13. The medicine bottle of claim 12, wherein the electrical contact is fast with an underside of the base member of the body.

14. The medicine bottle of claim 12, wherein the electrical contact is embedded in an underside of the base member of the body.
